(19) United States
(12) Patent Application Publication
(10) Pub. No.: US 2006/0094626 A1
(43) Pub. Date: May 4, 2006

(54) Streak free glass cleaner

(76) Inventor: Isaac B. Horton III, Raleigh, NC (US)

Correspondence Address: Isaac B. Horton, III, 8824 Stage Ford Road, Raleigh, NC, 27615, US

(21) Appl. No.: 11/299,496

(22) Filed: Dec. 12, 2005

Related U.S. Application Data
(63) Continuation-in-part of application No. 10/868,464, filed on Jun. 15, 2004.

(51) Int. Cl. C11D 17/00

(52) U.S. Cl. 510/407

(57) ABSTRACT

A cleaning composition in a concentrated form comprising a water-soluble organic solvent, at least one surfactant which comprises at least one naturally occurring amide, at least one additional surfactant, a chelating agent, and distilled water. Optionally, the cleaning composition further comprises at least one thixotropic agent and at least one foaming agent. The preferred embodiment of the cleaning composition can be applied to and removed from a hard glossy surface leaving the surface substantially streak free. The preferred embodiment of the cleaning composition comprises all-natural components.

### CROSS-REFERENCE TO RELATED APPLICATIONS

This nonprovisional utility patent application is copending with nonprovisional application Ser. No. 10/868,649 filed on Jun. 15, 2004, and nonprovisional application Ser. No. 10/868,541 filed on Jun. 15, 2004, and nonprovisional application Ser. No. 10/868,464 filed on Jun. 15, 2004.

### BACKGROUND OF THE INVENTION

(1) Field of the Invention

The present invention relates generally to a cleaning composition and, more particularly, to an all-purpose cleaning composition for use as a spray cleaner in cleaning textiles, glass, automobiles, and hard surfaces wherein the cleaner can be applied to and removed from a hard surface while leaving the cleaned surface substantially free of streaking.

(2) Description of the Prior Art

There are a large number of cleaning products currently on the market. Typically, cleaning compositions, detergents, and the like contain a combination of many components including but not limited to anionic surfactants, cationic surfactants, nonionic surfactants, builders, suds-stabilizers, buffers, disinfecting agents, wetting agents, and chelating agents. Often these cleaning compositions employ components that may have adverse effects on the environment such as phosphorous compounds, peroxygen compounds, chlorine bleach compounds, and fluorinated compounds. In addition to adversely affecting the environment many surfactant-based cleaners leave residue on hard, glossy surfaces which is difficult to completely remove by wiping. This incomplete residue removal results in streaks on the cleaned surface.

Prior art related to this invention is as follows:

U.S. Pat. No. 6,720,297 issued to Jenevein on Apr. 13, 2004 for a cleaning composition teaches a cleaning composition for treating and removing stains from a non-porous surface. The composition has one or more salts, such as quaternary ammonium salts, sulfates and chlorides, a chelator and a dispersant, dissolved in an aqueous solution of alcohol. The preferred salts are myristyltrimethylammonium bromide and benzethonium chloride, the chelator is tetrasodium salt ethylenediamine of tetraacetic acid, and the dispersant is polyvinyl alcohol. The cleaning composition is incorporated into a product, which has a non-woven polyester carrier impregnated with the cleaning composition.

U.S. Pat. No. 5,759,980 issued to Russo, et al. on Jun. 2, 1998 for a car wash teaches a novel car wash composition which substantially eliminates water-spotting. This novel car wash composition is comprised of: a surfactant package which is comprised of a first surfactant selected from the group consisting essentially of an anionic surfactant, a nonionic surfactant and mixtures thereof; and a second surfactant selected from the group consisting essentially of fluorosurfactant, a silicone surfactant, and mixtures thereof; and a substantive polymer that renders the surface to be cleaned more hydrophilic.

U.S. Pat. No. 6,732,747 issued to Wise on May 11, 2004 for a composition and method for cleaning and disinfecting a garbage disposal teaches an improved composition and method for cleaning and disinfecting a garbage disposal that does not require aerosol propellants or carbon dioxide gas generating reaction systems. The composition comprises a suds stabilizing surfactant and a disinfecting agent, plus other optional ingredients such as additional detergent surfactant and scouring agents. The required disinfecting agent is selected from the group consisting of quaternary ammonium compounds, halogenated compounds, phenolics, alcohols, aldehydes, oxidizing agents and mixtures thereof.

United States Patent Application Pub. No. 20040043041 to Baker, et al. on Mar. 4, 2004 for antimicrobial compositions and methods of use teaches compositions and methods for decreasing the infectivity, morbidity, and rate of mortality associated with a variety of pathogenic organisms and viruses. The reference invention also relates to methods and compositions for decontaminating areas colonized or otherwise infected by pathogenic organisms and viruses. Moreover, the reference invention relates to methods and compositions for decreasing the infectivity of pathogenic organisms in foodstuffs. In particular, decreased pathogenic organism infectivity, morbidity, and mortality are accomplished by contacting the pathogenic organism with an oil-in-water nanoemulsion comprising an oil, an organic solvent, and a surfactant dispersed in an aqueous phase. In some preferred embodiments, the solvent comprises an organic phosphate solvent. In still other embodiments, the organic phosphate-based solvent comprises dialkyl phosphates or trialkyl phosphates (e.g., tributyl phosphate).

U.S. Pat. No. 4,690,779 issued to Baker et al. on Sep. 1, 1987 for Hard surface cleaning composition teaches a hard surface cleaner having improved non-streaking/filming properties in which a combination of low molecular weight polymer (e.g., polyethylene glycol) and certain surfactants were combined.

U.S. Pat. No. 4,213,873 and U.S. Pat. No. 4,315,828 both issued to Church teach hard surface cleaners containing water, a cleaning agent (ammonium hydroxide or an alcohol), and a lubricity agent, which is typically a polymer, but allegedly can include a mixture of ammonium carbonate and ammonium carbamate.

E.P. 0393772 and E.P. 0428816 issued to Corn et al., describe hard surface cleaners containing anionic surfactants with ammonium counterions, and additional adjuncts.

G.B. 2,160,887 describes a cleaning system in which a combination of nonionic and anionic surfactants (including an alkanolamine salt alkyl sulfate) is contended to enhance cleaning efficacy.

WO 91/11505 describes a glass cleaner containing a zwitterionic surfactant, monoethanolamine and/or beta-aminoalkanols as solvents/buffers for assertedly improving cleaning and reducing filming spotting.

U.S. Pat. Nos. 5,252,245, 5,437,807, 5,468,423 and 5,523,024 all issued to Garabedian et al. and U.S. Pat. No. 5,585,342 issued to Choy et al all assigned to the Clorox Company teach improved glass and surface cleaners which combine either amphoteric or nonionic surfactants with solvents and effective buffers to provide excellent streaking/filming characteristics on glass and other smooth, glossy surfaces.

While these compositions can lead to a useful cleaning agent, a simpler composition that retains superior cleaning activity while reducing the number of components could simplify the manufacturing process, potentially reducing production costs without sacrificing product quality. Further, many of these cleaning compositions employ components that may have adverse effects on the environment or leave a residue on hard, glossy surfaces. Thus, there remains a need for a superior cleaning composition having a simple composition that is environmentally friendly, easily formulated, and cost effective.

Consumers find that sprayable compositions can be easy and very convenient to use. For good spray characteristics, such composition should be in the form of a low viscosity fluid. On the other hand, it may be desirable that the product has a viscosity sufficiently high in order to maintain a substantial concentration of cleaning composition on vertical or inclined surfaces for a time long enough to allow soil swelling to take place and to enable the product to work. In addition, for cleaning of windows, mirrors and other reflective or transparent surfaces, it is desired to reduce streaking on the cleaned surface. Therefore, it is an object of the present invention to provide a cleaning composition effective for cleaning transparent and reflective surface without streaking. It is a further object of the invention to provide a cleaning composition effective for the removal of soils with adequate rheology to allow the composition to be easily sprayed and to allow the composition to have a high residence time on vertical and inclined surfaces.

Thixotropy is a property exhibited by certain gels (semisolid, jellylike colloids). A thixotropic gel appears to be solid and maintains a shape of its own until it is subjected to a shearing (lateral) force or some other disturbance, such as shaking. It then acts as a sol (a semifluid colloid) and flows freely. Thixotropic behavior is reversible, and when allowed to stand undisturbed the sol slowly reverts to a gel. Common thixotropic gels include oil well drilling mud, certain paints and printing inks, and certain clays. Quick clay, which is thixotropic, has caused landslides in parts of Scandinavia and Canada.

Thixotropic agents can be added to solutions to form gels with these desired viscosity properties. Thixotropy is the property exhibited by certain gels of becoming fluid when stirred or shaken and returning to the semisolid state upon standing; this means that, as highly viscous gels, they liquefy without any change in the water content under the influence of mechanical stress, for example, by stirring or shaking. When the stress is removed, the high-viscosity state returns.

Several types of chemicals can impart thixotropic properties, including gums, cellulose derivatives, starches, chemical polymers, organic emulsifiers, and clay derivatives. Gum-type thickening agents that have been used for the composition of spray cleaners include xanthan gum, guar gum, locust bean gum, and alginates. Chemical polymers used as thickening agents include polyvinyl alcohol, polyacrylates, and hydrophobically-modified polyacrylates. Cellulose derivatives include hydroxypropyl methylcellulose.

Another natural colloidal compound that forms a thixotropic gel is diatomite, also known as diatomaceous earth or kieselguhr, which is composed of diatom shells made from opaline silica. Other thixotropic agents include fumed silica, castor based thixotropes, wax based anti-settling agents and exterior alkali swellable thickeners.

Clay derivatives include amine treated magnesium aluminum silicate, bentonite (aluminum silicate, a strongly hydrophilic colloidal clay consisting mainly of montmorillonite), colloidal silicic acid, white smectite clays and bleaching earth, attapulgite grades, mica grades, synthetic magnesium phyllosilicates (Laponite), layered silicates like activated bentonites, modified smectites, synthetic hectorite, and sepiolite.

Synthetic smectites are synthesized from a combination of metallic salts such as salts of sodium, magnesium and lithium with silicates, especially sodium silicates, at controlled ratios and temperature. This produces an amorphous precipitate that is then partially crystallized by any known method, such as high temperature treatment. The resultant product is then filtered, washed, dried and milled. In a particularly preferred embodiment, the smectite-type clay is used as a powder containing platelets that have an average platelet size of less than 100 nm. The platelet size as used herein refers to the longest lineal dimension of a given platelet.

Another possibility for enhancing the viscosity of a fluid composition is to incorporate a sufficient quantity of electrolyte together with a sufficient quantity of selected surfactant, so that the surfactant is present in a viscous phase, and thus increases the viscosity of the resulting composition, see US Patent App 20010056049.

It is also known to incorporate polymeric materials to enhance viscosity. One category of synthetic polymers used for this purpose are crosslinked polyacrylates, for instance those sold under the trade mark Carbopol. Natural polymers have also been used for this purpose, and in particular xanthan gum and its derivatives have been used. Personal washing products, especially shampoos, containing xanthan gum are described in for example U.S. Pat. No. 5,151,210 and EP-A-500423.

Detergent products containing other polymers have been described, for example in U.S. Pat. No. 5,286,405 and GB-A-2188060.

EP-A-271131 discloses a number of products intended for application to skin which are thickened with carrageenan so as to form gels. Many of these do not include surfactant. One product disclosed in this document is a cleansing composition, containing a low foaming nonionic surfactant.

EP-A-355908 teaches that polysaccharides which are capable of forming a reversible gel can be used to form viscous, yet mobile, fluid compositions by subjecting the composition to shear while gel formation takes place. The resulting compositions can be termed “shear gels”.

A number of polymers of biological origin, when in aqueous solution, have the ability to form so-called reversible gels which melt when heated but revert to a gel when cooled down subsequently. One well known example of a polysaccharide which forms reversible gels is agar. An aqueous solution containing a small percentage of agar is a mobile liquid when hot, but when left to cool it forms a gel with sufficient rigidity to maintain its own shape. Other naturally occurring polymers which can form reversible gels are carrageenan, furcelleran, gellan and pectin.

The formation of gels by natural polysaccharides arises from interaction between the polymer molecules. Reversible gels generally display a melting temperature or temperature range, referred to as the gel point. This is the temperature at which, on slow heating, the gel is observed to melt as this interaction largely disappears. Thus, above the gel point, the hot solution of polymer is mobile. When it cools below its gel point, the interaction of polymer molecules enables them to form a continuous and branched network which extends throughout the sample. In contrast with the formation of a continuous, branched network, some other materials which thicken water do so through merely local, transient entanglement of molecules. A discussion of polysaccharide gels, including their range of mechanical properties, is found in “Gels and Gelling” by Allan H Clark which is Chapter 5 in Physical Chemistry of Foods, Schwartzberg and Hartel, editors; published by Marcel Dekker 1992. In some instances there is hysteresis and the melting and setting temperatures are not identical.

The organic thixotropic agents are preferably anionic, cationic or non-ionic emulsifiers. Non-ionic emulsifiers are more preferably employed. As described in Ullmanns Enzyklopadie der technischen Chemie (Ullmann's Encyclopaedia of Industrial Chemistry), Volume 10, Chapter: Emulsionen (Emulsions), 4th edition, Verlag Chemie GmbH, Weinheim, these non-ionic emulsifiers include fatty acid esters of alcohols (N 101), ethylene glycol (N 102), polyethylene glycol (N 103), propylene glycol (N 104), glycerol, polyglycerol (N 105), sorbitol (N 106), pentaerythritol (N 107), glycerol esters (N 108) and sucrose (N 109), as well as fatty amines and fatty acid amides (N 200), polyglycerol ethers (N 300), for example polyglycerol ethers of fatty acid esters, such as glycerides, or sorbitol esters (N 304) and finally polypropylene glycol ethers (N 400).

Foaming agents can allow a composition to have increased residence time on a surface even though that composition is sufficiently non-viscous to be easily sprayed. Suitable foaming agents include polyethenoxy nonionic surfactants. It is known in the art that the ethoxylated nonyl phenols are nonionics which are particularly effective as foaming agents, especially where containing an average of about nine mols of ethylene oxide per mol. See U.S. Pat. No. 3,960,742 which is incorporated herein by reference in its entirety.

### SUMMARY OF THE INVENTION

The present invention is directed to an all-purpose cleaning composition for use as a spray cleaner in cleaning textiles, glass, automobiles, and hard surfaces wherein the cleaner leaves the cleaned surface substantially free of streaking. Thus, the present invention provides a spray cleaning composition comprising a water-soluble organic solvent, at least one surfactant which comprises at least one amide, a chelating agent, distilled water, optionally a thixotropic agent, and optionally a foaming agent; thereby providing a superior streak free cleaner having a simple composition that is easily formulated, and cost effective.

### DETAILED DESCRIPTION OF THE PREFERRED EMBODIMENTS

The present invention provides an all-purpose, streak-free spray cleaner with superior cleaning ability for a range of materials including but not limited to textiles, glass, automobiles, and hard surfaces. The cleaner is a concentrated composition which is preferably diluted prior to distribution to consumers for end use, such as by bottlers. The cleaning composition contains the following components:

(a) at least one water-soluble organic solvent present in a solubilizing effective amount;

(b) a first surfactant which comprises at least one amide which may be the product of the saponification of at least one fatty acid by an amino alcohol in a water-soluble organic solvent, wherein the first surfactant is present in a cleaning-effective amount;

(c) at least one additional surfactant present in a cleaning-effective amount;

(d) a chelating agent capable of chelating multivalent metal ions, wherein the chelating agent is present in an amount effective to prevent phase reversal of the oil-in-water emulsifier;

(e) optionally, at least one thixotropic agent,

(f) optionally a foaming agent, and

(g) the remainder, distilled water.

Additional adjuncts in small amounts such as fragrance, dye and the like can be included to provide desirable attributes of such adjuncts.

In the application, effective amounts are generally those amounts listed as levels of ingredients in the descriptions which follow hereto. Unless otherwise stated, amounts listed in percentages are in weight percents (%'s) of the composition.

Solvent

The solvent should be a water-soluble organic solvent. Further, the solvent is preferably a water-soluble organic alcohol. The most preferred water-soluble organic solvent is tetrahydrofurfuryl alcohol (THF-A). THF-A is an organic solvent that is completely miscible with water. THF-A has an extensive history of use as a highly versatile, high purity solvent. Due to its relatively benign nature and the fact that it is not oil-based, THF-A is generally regarded as a “green” solvent in industrial applications. THF-A readily biodegrades in soil, sludge, and water. The atmospheric half life is 13 hours. Unused THF-A is not classified as a hazardous waste under the Resource Conservation and Recovery Act.

Surfactants

The first surfactant is at least one amide. The preferred amide is at least one naturally occurring amide. The most preferred amide is a member of the group of amides comprising compounds with the structure CH₃(CH₂)ₓCONH(CH₂)₂OH, wherein the value of x is preferably any whole number between and including 14 and 22; CH₃(CH₂)ₓCH═CH(CH₂)_{y}CONH(CH₂)₂OH, wherein the value of x+y is preferably any whole number between and including 12 and 16; CH₃(CH₂)ₓCH═CH(CH₂)_{y}CH═CH(CH₂)_{z}CONH(CH₂)₂OH, wherein the value of x+y is preferably any whole number between and including 10 and 14; and mixtures thereof.

In another embodiment, the first surfactant may be the product of the saponification of at least one fatty acid by an amino alcohol in a water-soluble organic solvent. The preferred at least one fatty acid is chosen from the group comprising saturated fatty acids of the general formula CₓH₂ₓO₂, wherein the value of x is preferably any whole number between and including 16 and 24; monounsaturated or polyunsaturated fatty acids of the general formula CₓH_{(2x-y)}O₂, wherein the value of x is preferably any whole number between and including 16 and 20 and the value of y is preferably either 2 or 4; and mixtures thereof. A more preferred fatty acid is one chosen from the group comprising palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and mixtures thereof. The most preferred fatty acid is tall oil also known as pine oil. Tall oil is commercially available as MeadWestvaco L-5, marketed by MeadWestvaco, which comprises at least 95% tall oil fatty acid and less than 5% rosin acids. Any suitable fatty acid may contain rosin acids present in small amounts not to exceed about 5% by weight of the total weight of the fatty acid. The preferred amino alcohol is an ethanolamine. The most preferred amino alcohol is monoethanolamine.

The at least one additional surfactant is preferably at least one polyethylene oxide condensate of an alkyl phenol. Suitable additional surfactants are octylphenol ethoxylates that have the chemical formula C₈H₁₇(C₆H₄)O(CH₂CH₂O)ₓH, wherein the average value of x for any mixture of these compounds is preferably any number between and including 3 and 11. Optimally two surfactant mixtures are used, wherein the average value of x for the first additional surfactant mixture is preferably 4.5, and wherein the average value of x for the second additional surfactant mixture is preferably 9.5. These preferred additional surfactant mixtures are commercially marketed under the names Triton X-45 and Triton X-100 by The Dow Chemical Company.

Chelating Agent

The chelating agent is required to chelate multivalent metal ions and thus prevent phase reversal of the oil-in-water emulsifier. The preferred chelating agent is an aminocarboxylic acid salt. The most preferred chelating agent is tetrasodium ethylenediaminetetraacetic acid (Na₄EDTA). This compound is commercially marketed as an aqueous solution of about 38% by weight Na₄EDTA under the name Versene by The Dow Chemical Company.

Thixotropic Agent

The optional thixotropic agent according to the present invention illustratively includes gums, cellulose derivatives, starches, chemical polymers, organic emulsifiers, and clay derivatives. For example, a clay such as amine treated magnesium silicate, bentonite, montmorillonite, colloidal silicic acid, white smectite clays, attapulgite, mica, Laponite, activated bentonites, modified smectites, synthetic hectorite, sepiolite, kaolinite, and combinations thereof is added to the solution. The thixotropic agent typically accounts for up to 10% by weight. Preferably, the thixotropic agent is present from 0.1% to 2% by weight at final dilution. In one embodiment the thixotropic agent is chosen from the group consisting of xanthan gum, guar gum, locust bean gum, alginates, and combinations thereof. In another embodiment the thixotropic agent is chosen from the group consisting of polyvinyl alcohol, polyacrylates, hydrophobically modified polyacrylates, and combinations thereof. In still another embodiment the thixotropic agent is chosen from the group consisting of kieselguhr, fumed silica, castor based thixotropes, wax based anti-settling agents, exterior alkali swellable thickeners, and combinations thereof.

Foaming Agent

Optionally, the cleaning composition may comprise a foaming agent. By way of example, suitable foaming agents include polyethenoxy nonionic surfactants. The foaming agent, if present, should be present at about 1-10 parts by weights of the cleaning composition.

Water and Miscellaneous

The invention comprises a cleaning concentrate. Water may be present at levels of between about 6% and about 99.6% by volume. The most preferred amount of water is between about 47% and about 53% by volume. The preferred embodiment of this invention is a concentrated formulation which is preferably further diluted with water before end use. Some of the amides and acids that are present in this composition are known to undergo intermolecular and intramolecular Diels-Alder cyclization reactions. Some of the products of those reactions are known to have biological activity. Because these products are present in the cleaning composition of the current invention, and these products show biological activity, no additional biocide is necessary in this composition. By way of example, but not limitation one of these cyclization products is cyclopinolenic acid. Additionally, small amounts of adjuncts may be added to the composition for aesthetic qualities. These adjuncts include perfumes and dyes.

The invention further provides a method for formulating the cleaning concentrate. The method of formulating the cleaning composition of the present invention relies upon adherence to certain process parameters that lead to a unique product. The order of addition of the various components is critical. It is also vital that the process temperature be maintained throughout the procedure.

The composition is formulated in a reactor. The preferred reactor is a glass or Hastelloy reactor equipped with a reflux condenser and a means of stirring. The means of stirring may be a stir bar or agitator. The reactor should be clean prior to the reaction.

The reactor is charged with a water-soluble organic solvent. A suitable amount of water-soluble organic solvent is between about 3% and about 16% by weight of the total composition. The most preferred amount of water-soluble organic solvent is between about 3% and about 9% by weight of the total composition. In a preferred embodiment the water-soluble organic solvent is a water-soluble organic alcohol. In the most preferred embodiment the water-soluble organic solvent is tetrahydrofurfuryl alcohol (THF-A).

The reactor is charged with an amino alcohol. The stirring mechanism is employed while the reactor is charged with the amino alcohol. The stirring mechanism is continuously employed during the remainder of the process. A suitable amount of amino alcohol is between about 3% and about 9% by weight of the total composition. The amino alcohol undergoes a chemical reaction with the fatty acid in a 1 to 1 mole ratio. However, in the preferred embodiment the fatty acid is present in excess amounts. In a preferred embodiment the amino alcohol is an ethanolamine. In the most preferred embodiment the amino alcohol is monoethanolamine.

The contents of the reactor must be heated. The preferred temperature range for this process is between 75 and 90 degrees Celsius (C). The most preferred temperature range for this process is between 80 and 85 degrees C. This temperature range is maintained throughout the process. Immediately following additions of various components the batch temperature may fall below this range. At no time should the temperature be allowed to fall below 55 degrees C. The batch temperature should recover quickly to the required range.

At least one fatty acid is added to the reactor. A suitable amount of the at least one fatty acid is between about 7% and about 14% by weight of the total composition. The fatty acid is added via a clean gravity feed vessel. Alternatively a pump type vessel may be employed for the addition. After addition of the fatty acid the contents of the reactor are stirred for a first time period during which the reaction is monitored until it is complete. The reaction may be determined to be complete by any convenient method used in the art. Suitable methods include thin layer chromatography and high performance liquid chromatography.

After the reaction is determined to be complete, a first portion of distilled water is added rapidly. A suitable amount of the first portion of distilled water is between about 1% and about 9% by weight of the total composition. The mixture is stirred for a second time period which is sufficient to allow the composition to form a homogeneous mixture. Preferably the mixture is stirred for at least 10 minutes. The stirring time may increase dramatically corresponding with a scale-up of the process.

The at least one additional surfactant is rapidly added to the reactor. A suitable amount of each additional surfactant is between about 7% and about 30% by weight of the total composition. The most preferred amount of each additional surfactant is between about 8% and about 30% by weight of the total composition. The mixture is stirred for a time period which is sufficient to allow the composition to form a homogeneous mixture. Preferably the mixture is stirred for at least 10 minutes. The stirring time may increase dramatically corresponding with a scale-up of the process.

The chelating agent is added to the reactor. The preferred amount of chelating agent is between about 2% and about 8% by weight of the total composition. The chelating agent may be added to the present composition as an aqueous solution. In a preferred embodiment the chelating agent is added to the composition as an aqueous solution, and the chelating agent is present at a concentration of between about 36% and about 40% by weight in the aqueous solution. A commercially available aqueous solution of a chelating agent, such as Versene, may be used. A suitable amount of the aqueous solution of chelating agent is between about 7% and about 19% by weight of the total composition. The most preferred amount of the aqueous solution of chelating agent is between about 8% and about 19% by weight of the total composition.

Optionally, a thixotropic agent is added to the reactor. A suitable amount of thixotropic agent is up to about 10% by weight of the total composition. The most preferred amount is from 0.1% to 2% by weight of the final diluted composition.

Distilled water is added to the reactor. The distilled water makes up the balance of the composition. A preferred amount of distilled water for the second addition of distilled water is between about 4% and about 44% by weight of the total composition. The composition is allowed to cool to within 25 to 30 degrees C.

Optionally, after cooling and prior to commercial distribution, the composition may be passed through a filter to remove any debris acquired during the processing steps.

Certain modifications and improvements will occur to those skilled in the art upon a reading of the foregoing description. By way of example, applications for this cleaning composition may be extended to a cleaner for aircrafts which have exterior coatings similar or identical to automobiles. All modifications and improvements have been deleted herein for the sake of conciseness and readability but are properly within the scope of the following claims.

### DESIGN EXAMPLE(S)

This section outlines a design example, not necessarily optimized but illustrative of a suitable method, wherein the cleaning composition of the current invention may be formulated.

### Example

In this preferred embodiment of the method of formulating a cleaning composition in a concentrated form a reactor is charged with tetrahydrofurfuryl alcohol. The reactor is then charged with monoethanolamine, wherein the volume of monoethanolamine is one half the volume of the tetrahydrofurfuryl alcohol. The contents of the reactor are heated to within the range of 80 to 90 degrees C. The reactor is charged with tall oil (MeadWestvaco L-5) acquired from MeadWestvaco. The volume of tall oil is equal to the volume of the tetrahydrofurfuryl alcohol. The contents of the reaction are stirred until the reaction is determined to be complete. The reaction progress is followed by thin layer chromatography. The reactor is charged with a first portion of distilled water, wherein the volume of the first portion of distilled water is equal to the volume of the tetrahydrofurfuryl alcohol. The contents of the reaction are stirred for ten minutes. The reactor is charged with the additional surfactants Triton X-100 and Triton X-45, acquired from the Dow Chemical Company, wherein the amount of each additional surfactant is equal to the volume of the tetrahydrofurfuryl alcohol. The contents of the reactor are stirred for ten minutes. The reactor is charged with the commercially available aqueous solution of tetrasodium ethylenediaminetetraacetic acid Versene, wherein the amount of Versene is equal to the volume of the tetrahydrofurfuryl alcohol. The reactor is charged with the thixotropic agent, wherein the amount of the thixotropic agent is 2% by weight of the final composition. [IS THERE A SPECIFIC THIXOTROPIC AGENT THAT THE INVENTORS PREFER THAT WE INCLUDE HERE?]The reactor is charged with a second portion of distilled water, wherein the volume of the second portion of distilled water is equal to five times the volume of the tetrahydrofurfuryl alcohol, and the mixture is allowed to cool to about room temperature.

What is claimed is:

1. A cleaning composition in a concentrated form comprising:
(a) a water-soluble organic solvent,
(b) at least one amide surfactant,
(c) at least one additional surfactant,
(d) a chelating agent,
(e) the remainder distilled water,
wherein the cleaning composition can be applied to and removed from a hard surface without leaving residue or the appearance of streaks.

2. The cleaning composition according to claim 1, wherein the water-soluble organic solvent is a water-soluble organic alcohol.

3. The cleaning composition according to claim 1, wherein the amount of water-soluble organic solvent is between about 3% and about 16% by weight of the total composition.

4. The cleaning composition according to claim 1, wherein the at least one amide surfactant is the product of the saponification of at least one fatty acid by an amino alcohol.

5. The cleaning composition according to claim 4, wherein the amount of amino alcohol is between about 3% and about 9% by weight of the total composition.

6. The cleaning composition according to claim 4, wherein the at least one fatty acid is chosen from the group comprising saturated fatty acids of the general formula CₓH₂ₓO₂, wherein the value of x is any whole number between and including 16 and 24; monounsaturated or polyunsaturated fatty acids of the general formula CₓH_{(2x-y)}O₂, wherein the value of x is any whole number between and including 16 and 20 and y is either 2 or 4; and mixtures thereof.

7. The cleaning composition according to claim 4, wherein the at least one fatty acid may contain rosin acids present in small amounts not to exceed about 5% by weight of the total weight of the at least one fatty acid.

8. The cleaning composition according to claim 1, wherein the at least one amide surfactant is at least one fatty acid amide.

9. The cleaning composition according to claim 1, further comprising at least one thixotropic agent, wherein the amount of the at least one thixotropic agent is less than about 10% by weight of the total composition.

10. The cleaning composition according to claim 9, wherein the amount of the at least one thixotropic agent is between about 0.1% and about 2% by weight of the total composition.

11. The cleaning composition according to claim 9, wherein the at least one thixotropic agent is selected from the group consisting of gums, cellulose derivatives, starches, chemical polymers, organic emulsifiers, clay derivatives, and combinations thereof.

12. The cleaning composition according to claim 19, wherein the at least one thixotropic agent is selected from the group consisting of xanthan gum, guar gum, locust bean gum, alginates, and combinations thereof.

13. The cleaning composition according to claim 19, wherein the at least one thixotropic agent is selected from the group consisting of polyvinyl alcohol, polyacrylates, hydrophobically modified polyacrylates, and combinations thereof.

14. The cleaning composition according to claim 19, wherein the at least one thixotropic agent is selected from the group consisting of kieselguhr, fumed silica, castor based thixotropes, wax based anti-settling agents, exterior alkali swellable thickeners, and combinations thereof.

15. The cleaning composition according to claim 9, wherein the at least one thixotropic agent is selected from the group consisting of amine treated magnesium silicate, bentonite, montmorillonite, colloidal silicic acid, white smectite clays, attapulgite, mica, Laponite, activated bentonites, modified smectites, synthetic hectorite, sepiolite, kaolinite, and combinations thereof.

16. The cleaning composition according to claim 1, further comprising at least one foaming agent.

17. The cleaning composition according to claim 16, wherein the at least one foaming agent is a polyethenoxy nonionic surfactant.

18. The cleaning composition according to claim 16, wherein the at least one foaming agent is present at 1-10 parts per weight of the cleaning composition.

19. A cleaning composition in a concentrated form comprising:
(a) a water-soluble organic solvent;
(b) at least one amide surfactant, wherein the at least one amide surfactant is the product of the saponification of at least one fatty acid by an amino alcohol;
(c) at least one additional surfactant, wherein the at least one additional surfactant is a polyethylene oxide condensate of an alkylphenol;
(d) a chelating agent, wherein the chelating agent is an aminocarboxylic acid salt; and
(e) the remainder distilled water,
wherein the cleaning composition can be applied to and removed from a hard surface without leaving residue or the appearance of streaks.

20. The cleaning composition according to claim Error! Reference source not found., wherein the amount of the at least one thixotropic agent is between about 0.1% and about 2% by weight of the total composition.
